(19) United States
(12) Patent Application Publication
(10) Pub. No.: US 2022/0316694 A1
(43) Pub. Date: Oct. 6, 2022

(54) POLE ILLUMINATION SYSTEM AND METHOD OF USE

(71) Applicant: Guillermo Castillo, Arlington, TX (US)

(72) Inventor: Guillermo Castillo, Arlington, TX (US)

(21) Appl. No.: 16/380,980

(22) Filed: Apr. 10, 2019

Related U.S. Application Data
(60) Provisional application No. 62/655,542, filed on Apr. 10, 2018.

(51) Int. Cl. F21V 33/00; F21V 23/06; B24D 15/02

(52) U.S. Cl. CPC F21V 33/0084; F21V 23/06; B24D 15/02

(57) ABSTRACT

A pole illumination system allows a person to shine light on a work surface even when that work surface is at a distance from the person. An adaptor attaches to the head of a pole and allows abrasives to be attached thereto. The adaptor has lights that illuminate from the sides thereof to cast light about the work surface or space.

### BACKGROUND

1. Field of the Invention

The present invention relates generally to hand tool systems, and more specifically, to a pole illumination system for providing light at a distance where a tool is held away from the user's body by an extension arm or the like.

2. Description of Related Art

Hand tool systems are well known in the art and are effective means to facilitate or simplify work or tasks generally performed or controlled by hand. For example, sanders allow a person to hold a handle and move the tool about to alter the surface smoothness of an object through friction or motion. Sanders are commonly used at the end of a handle to reach difficult locations such as roofs, corners or confined spaces.

One of the problems commonly associated with hand tools in general and sanders specifically is their limited use. For example, the ability of the person using the tool is limited by the distance they are from the workspace and their ability to project light to the workspace from their location. The surface finish of the work spot is commonly determined by sight or touch and when working at a distance the difficulty in tactile evaluation is limited.

Accordingly, although great strides have been made in the area of hand tools, specifically sanders, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a front view of a pole illumination system in accordance with a preferred embodiment of the present application;

FIG. 2 is a perspective view of the adapter of FIG. 1;

FIG. 3 is a bottom side perspective view of an alternative embodiment of the adapter of FIG. 2;

FIG. 4 is a cross-sectional side view of the system of FIG. 1; and

FIG. 5 is a flowchart of the preferred method of use of the system of FIG. 1.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional hand tools and particularly sanders. Specifically, the invention of the present application enables light to be placed directly at the workspace. This and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

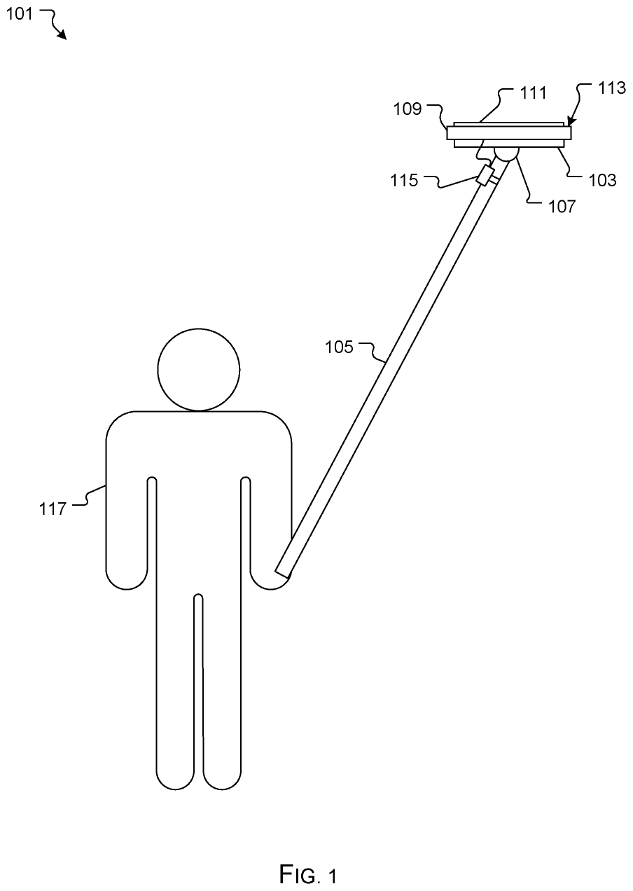

Referring now to the drawings wherein like reference characters identify corresponding or similar elements throughout the several views, FIG. 1 depicts a front view of a pole illumination system in accordance with a preferred embodiment of the present application. It will be appreciated that system 101 overcomes one or more of the above-listed problems commonly associated with conventional hand tool systems particularly hand sanders.

In the contemplated embodiment, system 101 includes head 103 pivotally attached to a pole 105 via a hinge 107. The head 103 is removably attached to an adaptor 109. The adaptor 109 is configured to allow an abrasive pad 111 to be removably attached on the top surface 113 thereof. The adaptor 109 is also in electrical communication with a power source 115.

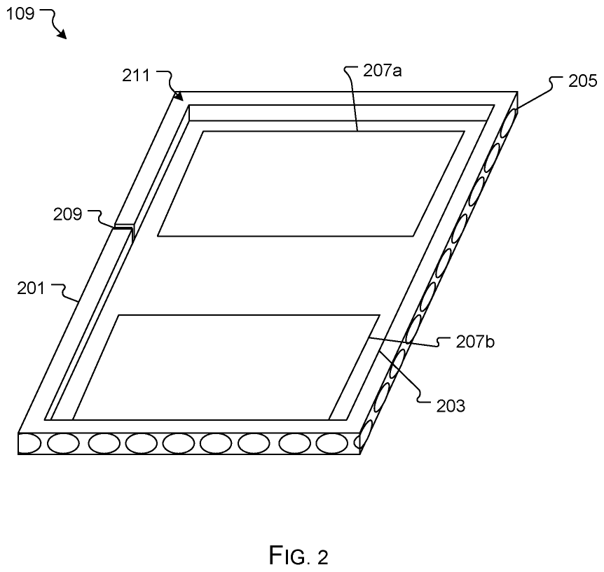

Referring now to FIG. 2 the adaptor 109 is depicted. Adaptor 109 includes a body 201 with a pocket 203 extending inward from the bottom surface 211 of thereof and configured to allow the head 103 to seat therein. The outer edge of the body 201 is configured to house a series of light sources 205 therein. Adhesive pads 207 are attached to the bottom of the pocket 203 and are configured to join the head 103 to the adapter 109. The body 201 also includes a power connector 209 to allow electricity from the power source 155 to activate the light sources 205.

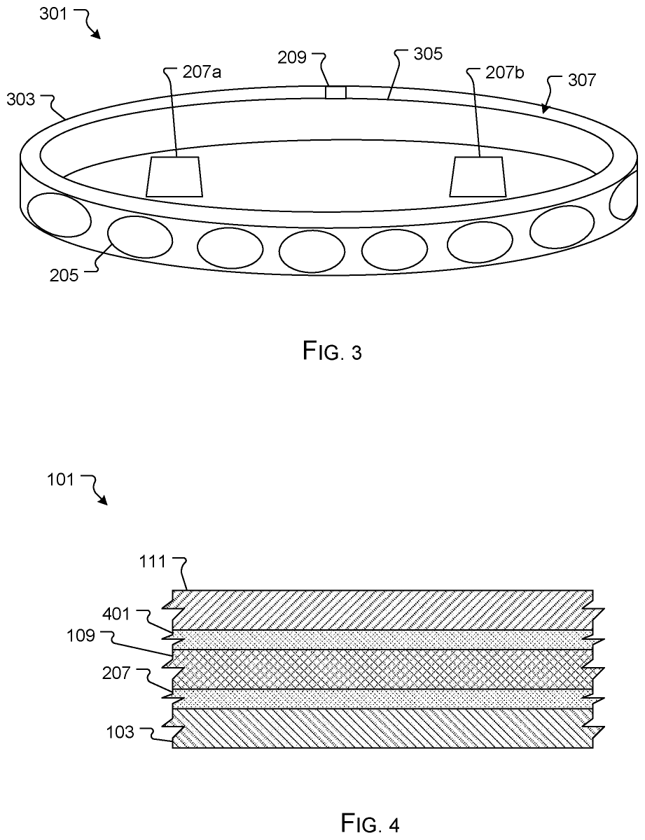

Referring now to FIG. 3 an alternative embodiment of the adaptor 109 is depicted. Embodiment 301 includes similar features as adaptor 109 where the body 201 has been replaced by body 303 of a generally circular form with pocket 305 extending inward from the bottom surface 307 thereof. It will be understood that the body 303 could be of any shape or configuration so as to facilitate connection with a head 103.

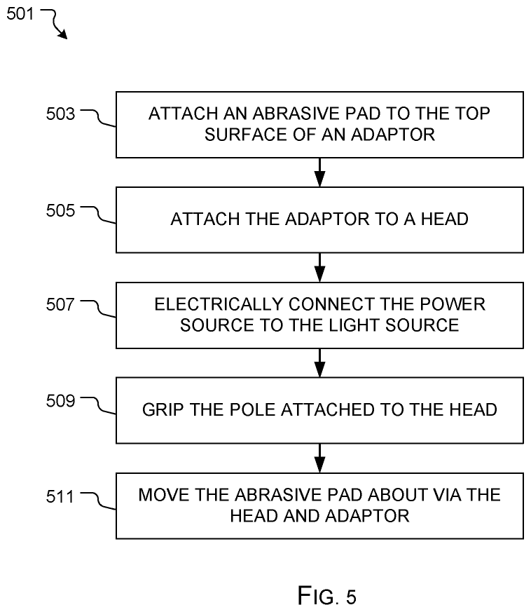

The system 101 in an assembled state is shown in FIG. 4. The abrasive pad 111 is attached to the adaptor via an adhesive layer 401, which in turn in attached to the head 103 via the adhesive pads 207.

While the present embodiment includes adhesive pads 207 and an adhesive layer 401 it is contemplated that any method of removably connecting the head 103 to the adaptor 109 and the abrasive pad 111 is contemplated. For example, hook and loop fasteners and the like could also be used.

In use, the abrasive pad 111 is attached to the adaptor 109 via the adhesive layer 401 which is in turn attached to the head 103 via the adhesive pads 207. The adaptor 109 is connected to the power source 115 so that the light sources 205 illuminate the area around the head 103. A user 117 then grips pole 105 to move the abrasive pad 111 about to alter the surface finish of a work surface.

It should be appreciated that one of the unique features believed characteristic of the present application is that adaptor 109 enables the illumination of the area around the head 103 via the light sources 205. It will be further appreciated that the area at the end of pole 105 is able to be illuminated.

Referring now to FIG. 5 the preferred method of use of the system 101 is depicted. Method 501 includes attaching an abrasive pad to the top surface of an adaptor 503, attaching the adaptor to a head 505, electrically connecting the power source to the light source 507, gripping a pole attached to the head 509 and moving the abrasive pad about via the head and adaptor 511.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed;:

1. A pole illumination system comprising:
at least one adaptor removably attached to at least one head;
the at least one head pivotally attached to a pole via a hinge;
the adaptor having at least one abrasive pad attached to the top surface thereof;
the adaptor having at least one light source;
wherein the light source of the adaptor projects light to the area around the head.

2. The system of claim 1 wherein the adaptor comprises a body with a pocket extending inward from the bottom surface and encloses at least one light source therein.

3. The method of illuminating a workspace given the system of claim 1, comprising:
attaching an abrasive pad to the top surface of an adaptor;
attaching the adaptor to a head;
electrically connecting the power source to the light source;
griping a pole attached to the head; and
moving the abrasive pad about via the head and adaptor.
